(19) United States
(12) Patent Application Publication
(10) Pub. No.: US 2015/0248713 A1
(43) Pub. Date: Sep. 3, 2015

(54) BILLING-INFORMATION COOPERATIVE PROCESSING SYSTEM AND BILLING-INFORMATION COOPERATIVE PROCESSING METHOD

(71) Applicant: HITACHI SYSTEMS, LTD., Tokyo (JP)

(72) Inventors: Hisako Morita, Shinagawa-ku (JP); Mineyuki Tamura, Shinagawa-ku (JP)

(73) Assignee: Hitachi Systems, Ltd., Shinagawa-ku, Tokyo (JP)

(21) Appl. No.: 14/430,436

(22) PCT Filed: Sep. 26, 2012
(86) PCT No.: PCT/JP2012/074658

§ 371 Date: Mar. 23, 2015

(51) Int. Cl. G06Q 30/04

(52) U.S. Cl. CPC G06Q 30/04

(57) ABSTRACT

A billing-information cooperative processing system can eliminate charge omission by comparing billing-target-information demanded by a charging system with billing information calculated in a SaaS application. The billing-information cooperative processing system is provided with charging system 1, and SaaS application system 2 which provides the SaaS application to a user and sends charging information of the user to the charging system 1 based on a charging type of the SaaS application. The SaaS application system 2 obtains billing-target user information of a charging target month from the charging system; notifies the charging system of charging information of the user based on the billing-target user information; after the notification to the charging system is completed, checks whether information unregistered to the charging system is present or not; and, if the unregistered information is present, notifies a manager of the SaaS application system of the information that the unregistered information is present.

### CROSS REFERENCE TO RELATED APPLICATIONS

This application is entitled to the benefit of and incorporates by reference subject matter disclosed in International Patent Application No. PCT/JP2012/074658 filed on Sep. 26, 2012.

### TECHNICAL FIELD

The present invention relates to a billing-information cooperative processing system of billing prices in a charging system, which cooperates with, for example, a credit-card settlement company, and in a SaaS application system. The present invention particularly relates to a billing-information cooperative processing system and a billing-information cooperative processing method that can register billing information to the charging system for all of demanded users even in a case that billing prices of the SaaS application system are registered to the charging system and that billing-target users demanded from the charging system and billing-target users managed in a database in the SaaS application system do not match with each other.

### BACKGROUND ART

Examples of a conventional charging method of applications and contents include those described in Japanese Patent Application Laid-Open No. 2011-90688, in which charging demands of applications are processed by a billing server, and Japanese Patent Application Laid-Open No. 2002-373297, in which billing information of contents is processed by an invoice printing server.

As a method of registering the charging information of a SaaS application serving as a charging target in a cloud environment to a charging system, which cooperates with, for example, a credit-card settlement company, the registration is carried out by giving a notification of the charging information of users serving as billing-targets in the side of SaaS application system to the side of the charging system.

### SUMMARY OF THE INVENTION

However, in the methods described in Patent Documents 1 and 2, although processing of the charging information is carried out in the billing server or the invoice printing server, billing-information cooperation of the charging demands of applications and the charging information of contents with the providing side of the applications or contents has not been carried out.

Even as a registration process of the billing prices of the SaaS application system to the charging system, which carries out cooperation with, for example, a credit-card settlement company, the information serving as billing-targets in the side of the SaaS application system has been registered to the charging system.

Therefore, cooperation of the billing prices between the charging system and the SaaS application system has not been carried out, and there has been a possibility of billing omission.

Therefore, it is an object of the present invention to provide a billing-information cooperative processing system and a billing-information cooperative processing method which can eliminate billing omission by giving a notification of the billing information corresponding to a charging target user demanded from the side of the charging system instead of giving a notification of the information serving as a billing-target in the side of the SaaS application system to the charging system and by comparing the billing-target-information demanded from the charging system with the billing information calculated in the SaaS application system.

The above and other objects and novel characteristics of the present invention will be apparent from the description of the present specification and the accompanying drawings.

The following is a brief description of an outline of the typical invention disclosed in the present application.

That is, an outline of the typical invention is a billing-information cooperative processing system including: a charging system that charges and bills a user and a SaaS application system that provides a SaaS application to the user and sends charging information of the user to the charging system based on a charging type of the SaaS application. The SaaS application system has a processing unit that obtains billing-target user information of a charging target month from the charging system; notifies the charging system of charging information of the user based on the billing-target user information; after the notification to the charging system is completed, checks whether billing information unregistered to the charging system is present or not; and, if the unregistered information is present, notifies a manager of the SaaS application system of information that the unregistered information is present.

Among the inventions disclosed in the application, the advantageous effects obtained by the typical invention will be briefly explained as below.

That is, as the effects obtained by the typical invention, cooperation of the charging billing information and prevention of charging omission can be achieved by giving a notification of the billing information with respect to a billing-target owner demanded from the side of the charging system to the charging system, and checking whether the billing information calculated in the side of the SaaS application system is unregistered or not in cooperation of the billing information between the charging system and the SaaS application system.

### BRIEF DESCRIPTIONS OF THE DRAWINGS

FIG. 1 is a configuration diagram showing a configuration of a billing-information cooperative processing system according to an embodiment of the present invention;

FIG. 2 is a drawing showing a configuration of a billing-price-information management table used in the billing-information cooperative processing system according to the embodiment of the present invention; and

FIG. 3 is a flow chart showing billing-information cooperative processing of the billing-information cooperative processing system according to the embodiment of the present invention.

### DETAILED DESCRIPTION OF PREFERRED EMBODIMENT

Hereinafter, embodiments of the invention will be explained in detail with reference to the drawings. Note that, in all drawings for explanation of the embodiments, the same members basically have the same signs and their repetitive explanation will be omitted.

<Configuration of Billing-Information Cooperative Processing System>

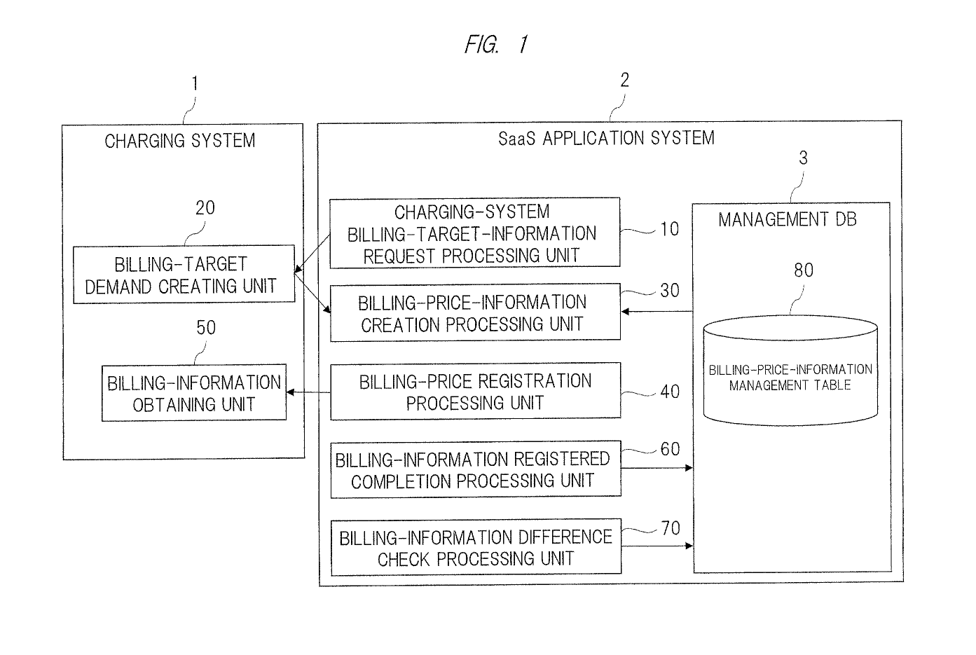

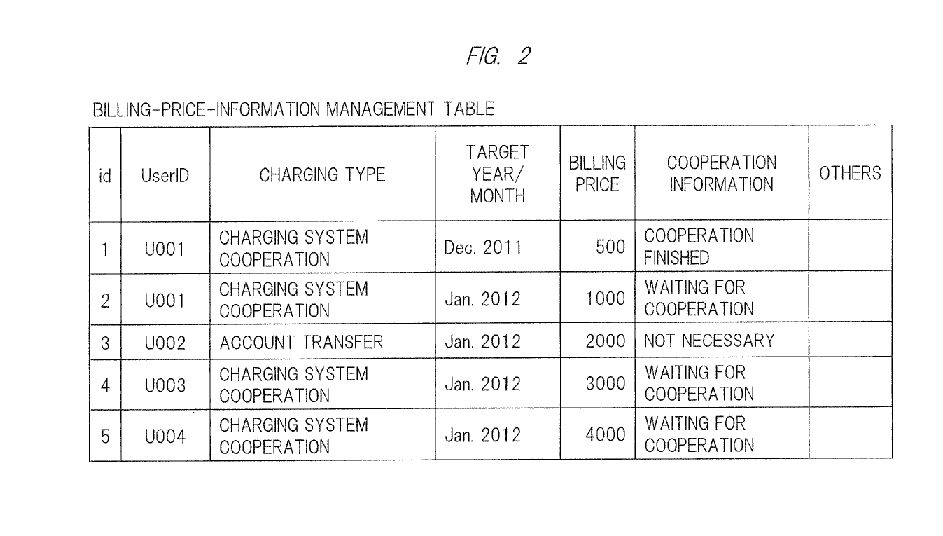

A configuration of a billing-information cooperative processing system according to the embodiment of the present invention will be explained by FIG. 1 and FIG. 2. FIG. 1 is a configuration diagram showing the configuration of the billing-information cooperative processing system according to the embodiment of the present invention, FIG. 2 is a drawing showing a configuration of a billing-price-information management table used in the billing-information cooperative processing system according to the embodiment of the present invention.

In FIG. 1, the billing-information cooperative processing system includes a charging system 1, which cooperates with, for example, a credit-card settlement company, and a SaaS application system 2, which carries out processing of, for example, providing SaaS applications.

A management database (DB) 3 is provided in the SaaS application system 2, and a billing-price-information management table 80 used in billing-information cooperative processing is stored in the management database (DB) 3.

The charging system 1 is provided with a billing-target demand creating unit 20 and a billing-information obtaining unit 50 and, in addition to that, is provided with a processing unit (not shown) for carrying out processing such as cooperation with a credit-card company.

The billing-target demand creating unit 20 receives billing-target-information requests from the SaaS application system 2 and creates billing-target demand information, which is to be sent to the SaaS application system 2.

The billing-information obtaining unit 50 obtains billing information from the SaaS application system 2 and registers the information in the charging system 1.

The SaaS application system 2 is provided with a charging-system billing-target-information request processing unit 10, a billing-price-information creation processing unit 30, a billing-price registration processing unit 40, a billing-information registered completion processing unit 60, and a billing-information difference check processing unit 70 and, in addition to them, is provided with a processing unit (not shown), which carries out processing such as provision of SaaS applications.

The charging-system billing-target-information request processing unit 10 generates billing-target-information requests to the charging system 1 and sends the requests to the charging system 1.

With respect to billing-target users of the billing-target demand information obtained from the charging system 1, the billing-price-information creation processing unit 30 obtains the information of the billing-target users from the billing-price-information management table 80 of the management database (DB) 3, which is managed in the SaaS application system 2, and creates billing-price-information.

The billing-price registration processing unit 40 registers the billing-price-information, which has been created by the billing-price-information creation processing unit 30, in the side of the charging system 1.

The billing-information registered completion processing unit 60 registers, with respect to the billing-price-information management table 80 of the management database (DB) 3 in the SaaS application system 2, that the billing information of the users serving as the targets has completed cooperation with the charging system 1.

The billing-information difference check processing unit 70 checks if all of the information, which has been created in the SaaS application system 2 and requires cooperation with the charging system 1, has completed cooperation and if unregistered information is not present.

In FIG. 2, the billing-price-information management table 80 has, as items, an id, a user ID, a charging type, target year/month, a billing price, cooperation information, and others.

Serial numbers imparted to billing-price-information management information are stored as “ids”, and identification numbers of users serving as charging targets are stored as “User IDs”.

The information indicating cooperation counterparts of charging data is stored as “charging type”. For example, the information for judging the contents such as the way of receiving money by cooperation with the charging system, by account transfer, or by invoice issuing is stored.

The information of the charging-target year and month is stored as “target year/month”, price information to be billed to the users is stored as “billing price”, and the information indicating the cooperation state with the charging system 1 is stored as “cooperation information”.

Other information about charging, etc. is stored as “others”.

<Billing-Information Cooperative Processing>

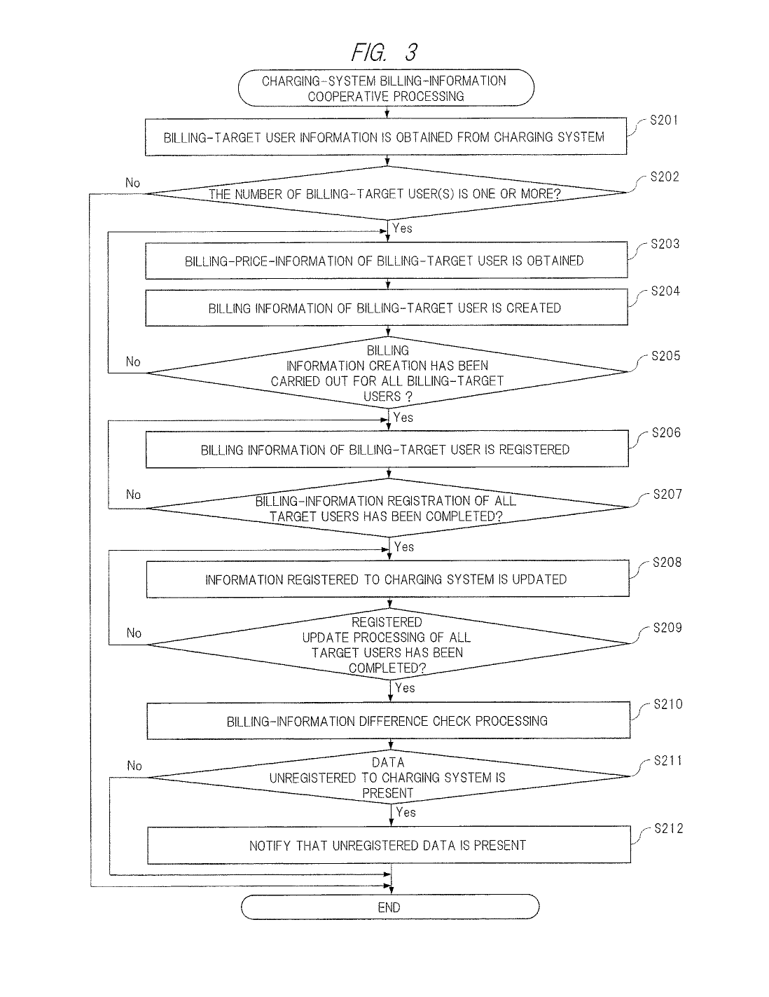

Then, billing-information cooperative processing of the billing-information cooperative processing system according to the embodiment of the present invention will be explained by FIG. 3. FIG. 3 is a flow chart showing the billing-information cooperative processing of the billing-information cooperative processing system according to the embodiment of the present invention, and shows processing that requires cooperation from the side of the SaaS application system 2 to the charging system 1.

First, in the SaaS application system 2, after the billing price of a target month is collected, a request of billing-target-information is sent to the charging system 1 by the charging-system billing-target-information request processing unit 10, and billing-target user information serving as a billing-target demand of the target month is obtained from the billing-target demand creating unit 20 of the charging system 1 (step S201).

Then, whether there is one or more billing-target user information serving as the billing-target demand obtained in step S201 is judged (step S202), and the processing is terminated if it is judged in step S202 that there is not one or more billing-target user information.

If it is judged in step S202 that there is one or more billing-target user information, the billing-price-information of the billing-target user serving as the target is obtained from the billing-price-information management table 80 by the billing-price-information creation processing unit 30 (step S203), and the billing information of the billing-target user is created according to the billing-price-information obtained in step S203 (step S204).

Then, it is judged whether the billing information has been created for all of the billing-target users obtained in step S201 or not (step S205). If it is judged in step S205 that the billing information has not been created for all of the billing-target users, the processing returns to step S203, and the processes are repeatedly carried out.

Then, if it is judged in step S205 that the billing information has been created for all of the billing-target users, the billing information of the billing-target user created in step S204 is sent to the charging system 1 by the billing-price registration processing unit 40 (step S206), and, in the charging system 1, the billing information is registered by the billing-information obtaining unit 50.

Then, whether registration of the billing information of all the target users has been completed or not is judged (step S207). If it is judged in step S207 that registration of the billing information of all the target users has not been completed, the processing returns to step S206, and the process is repeated until the registration is completed.

If it is judged in step S207 that registration of the billing information of all the target users has been completed, the billing-information registered completion processing unit 60 stores, for example, “cooperation finished” in a cooperation information field of the billing-price-information management table 80 to update the field to the information that the cooperation with the charging system 1 has been completed (step S208).

Then, it is judged whether update of the cooperation information has been completed or not with respect to all of the billing-information registered users registered to the charging system 1 (step S209). If it is judged in step S209 that update of the cooperation information has not been completed with respect to all of the billing-information registered users, the processing returns to step S208, and the process is repeated until the update of the cooperation information is completed with respect to all of the billing-information registered users.

If it is judged in step S209 that update of the cooperation information has been completed with respect to all of the billing-information registered users, a difference(s) in the information of the billing-price-information management table 80 is/are checked (step S210).

In step S210, the information in the billing-price-information management table 80 that matches the target year/month and has “charging system cooperation” as the charging type, but has “waiting for cooperation” as the cooperation information is obtained.

Then, it is judged whether the number of the data item(s) obtained in step S210 is one or more and whether there is the data unregistered to the charging system 1 (step S211). If it is judged in step S211 that there is no data unregistered to the charging system 1, the processing is terminated.

If it is judged in step S211 that there is the data unregistered to the charging system 1, the data unregistered to the charging system 1 is present, and charge omission may be present. Therefore, a manager is notified of the fact that the unregistered data is present by transmitting a log and a mail to the manger (step S212).

In this manner, in the present embodiment, cooperation of the charging billing information and prevention of charging omission can be achieved by sending the demand for the billing-target-information to the charging system 1, giving a notification of the billing information with respect to the billing-target user(s) demanded from the side of the charging system 1 to the charging system 1, and checking whether the billing information calculated in the side of the SaaS application system 2 is unregistered or not.

As described above, the invention by the inventors has been specifically explained according to the embodiments, however, it is obvious that the invention is not limited to the embodiments and various changes may be made without departing from the scope of the invention.

The present invention relates to a billing-information cooperative processing system of billing prices in a charging system, which cooperates with a credit-card settlement company, and in a SaaS application; and the present invention can be widely applied to an apparatus, system, etc. which transmit/receive charging information between the charging system and a providing side of applications and contents.

While the present invention has been illustrated and described with respect to a particular embodiment thereof, it should be appreciated by those of ordinary skill in the art that various modifications to this invention may be made without departing from the spirit and scope of the present.

What is claimed is:

1. A billing-information cooperative processing system comprising:
a charging system that charges and bills a user; and
a SaaS application system that provides a SaaS application to the user and sends charging information of the user to the charging system based on a charging type of the SaaS application;
wherein the SaaS application system has a processing unit that obtains billing-target user information of a charging target month from the charging system;
notifies the charging system of charging information of the user based on the billing-target user information; after the notification to the charging system is completed, checks whether billing information unregistered to the charging system is present or not; and, if the unregistered information is present, notifies a manager of the SaaS application system of information that the unregistered information is present.

2. The billing-information cooperative processing system according to claim 1,
wherein the SaaS application system has a management database having a billing-price-information management table that stores information specifying the user, information of the charging type, information of target year/month, information of a billing price, and cooperation information about cooperation with the charging system; and
the processing unit carries out processing based on the information stored in the billing-price-information management table.

3. The billing-information cooperative processing system according to claim 2,
wherein the processing unit has:
a charging-system billing-target-information request processing unit that sends a request of billing-target-information to the charging system;
a billing-price-information creation processing unit that, with respect to a billing-target user of billing-target demand information obtained from the charging system, obtains information of the billing-target user and creates billing-price-information based on the billing-price-information management table;
a billing-price registration processing unit that registers the billing-price-information created by the billing-price-information creation processing unit to a side of the charging system;
a billing-information registered completion processing unit that registers information to the billing-price-information management table, the information that the billing-price-information has been registered to the side of the charging system by the billing-price registration processing unit and that cooperation with the charging system has been completed; and
a billing-information difference check processing unit that, if the cooperation information, among the cooperation information of the user having information which cooperates with the charging system as the information of the charging type of the billing-price-information management table, is information indicating non-cooperation with the charging system and indicating presence of information unregistered to the charging system, notifies the manager of the SaaS application system of the information that the unregistered information is present.

4. A billing-information cooperative processing method of a billing-information cooperative processing system comprising:
a charging system that charges and bills a user; and
a SaaS application system that provides a SaaS application to the user and sends charging information of the user to the charging system based on a charging type of the SaaS application;
wherein the SaaS application system obtains billing-target user information of a charging target month from the charging system; notifies the charging system of charging information of the user based on the billing-target user information;
after the notification to the charging system is completed, checks whether billing information unregistered to the charging system is present or not; and, if the unregistered information is present, notifies a manager of the SaaS application system of information that the unregistered information is present.
